(19) United States
(12) Patent Application Publication
(10) Pub. No.: US 2006/0064528 A1
(43) Pub. Date: Mar. 23, 2006

(54) Privileged resource access

(75) Inventors: Donald C. Soltis, JR., Fort Collins, CO (US); Dale Morris, Steamboat Springs, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/944,266

(22) Filed: Sep. 17, 2004

(51) Int. Cl. G06F 13/24

(52) U.S. Cl. 710/260

(57) ABSTRACT

At least one entry in an original interrupt vector table is replaced with an instruction set to handle access to a privileged resource. An operating system privilege level is modified to one or more resources. Subsequent access to the privileged resource causes an interrupt. Processing of the interrupt is directed to the instruction set to handle access to the privileged resource.

### BACKGROUND

Computer systems are generally designed with an Operating System (OS) that runs upon system hardware and applications which run on top of the operating system. Typically, computer processors have been designed with features such as privilege levels and privileged instructions which allow the operating system to manage the system. A higher privilege level of the operating system shields the system and other applications from direct access by lower privilege level application instructions.

A computer system may be virtualized by using a third layer of software termed a hypervisor, also known as a Virtual Machine Monitor. A hypervisor is a specialized type of operating system. The actual operating system then runs on top of the hypervisor, and although the operating system operates as if it is directly managing the system, operating system attempts to do so are captured by the hypervisor. In such hypervisor systems, the system management is performed invisibly to the operating system. Typically, computer processors have provided additional levels of privilege so that the hypervisor is more privileged than the operating system, giving the hypervisor direct control over certain hardware and instructions. In such systems, the operating system does not have direct system control, but the operating system remains more privileged than applications.

The hypervisor virtualizes the system and makes it appear to the operating system that it directly controls the system. This approach makes it possible for multiple operating systems to run atop the hypervisor, each operating system thinking it has exclusive, direct control of the system. A full hypervisor virtualizes the entire system, including memory and I/O devices.

Development of a hypervisor takes considerable effort. Further, virtualizing an entire system using a hypervisor increases system overhead even in circumstances when a subset of all system resources are to be virtualized.

### BRIEF DESCRIPTION OF THE DRAWINGS

FIG. 1 is a block diagram of a system according to an example embodiment.

FIG. 2A is a diagram of a system according to an example embodiment.

FIG. 2B is a diagram of a system according to an example embodiment.

FIG. 3 is a flow diagram of a method according to an example embodiment.

FIG. 4 is a flow diagram of a method according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, Application Specific Integrated Circuit (ASIC), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

The present disclosure provides, among other things, the ability to interrupt execution of processes or capture access requests for resources utilizing a resource management layer. In some embodiments, this includes virtualizing and emulating processes and resources. However, as will be apparent from the following disclosure, actual virtualization or emulation is may or may not be included in a particular embodiment to practice the inventive subject matter.

In some embodiments, a resource management layer is a piece of software that runs laterally to an operating system on top of the system hardware. The resource management layer may also be thought of as a thinvisor. The resource management layer controls access to a first set of resources and the operating system controls a second set of resources. However, the operating system and applications running upon the operating system access the first set of resources via the resource management layer. The operating system and applications execute with less than normal privilege, such that they do not have direct access to privileged resources controlled by the resource management layer. When an attempt is made to access a privileged resource, an interruption occurs into the resource management layer. Upon capturing an interrupt, the resource management layer causes single-step execution of the access attempt, providing full privilege to the privileged resource for a single instruction and then returning control to the resource management layer.

Interrupt, as used herein, is intended as a broad term. Interrupt is intended to encompass other synonymous and related terms such as fault, trap, exception, and the like.

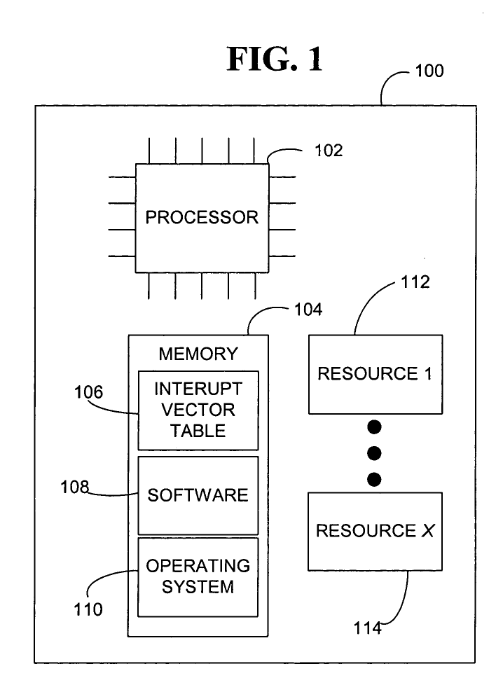

FIG. 1 is a block diagram of a system 100 according to an example embodiment. In this embodiment, the system 100 includes various elements for performing various tasks associated with an example embodiment of a resource management layer. The system 100 includes a processor 102, a memory 104, and one or more resources, such as resource 1 112 and resource X 114. The memory 104 of the system 100 includes an interrupt vector table 106, software 108, and an operating system 110.

The processor 102 of the system 100 embodiment of FIG. 1 represents a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. The processor 102 executes instructions. The processor 102 also includes a control unit that organizes data and program storage in memory, such as memory 104, and transfers data and other information in and out of the system 100 and, in some embodiments, to and from one or more network connections (not shown).

The memory 104 represents one or more mechanisms for storing data. For example, the memory 104, in various embodiments, includes one or more of a read only memory (ROM), random access memory (RAM), magnetic disk storage media, optical storage media, flash memory devices, and/or other volatile and non-volatile machine-readable media. In other embodiments, the memory includes any appropriate type of storage device or memory 104. Although only one memory 104 is shown, multiple memories 104 of various types and multiple types of storage devices can be present.

The interrupt vector table 106 stored in the memory 104 is a table of interrupt vectors. The interrupt vectors are pointers, such as memory addresses, to routines that handle interrupts. In some embodiments, the interrupt vector table comprises a set of memory locations which contain interrupt-handling routines for a particular interrupt vector. In some embodiments, the interrupt vector table comprises 256 four-byte pointers and resides in the first 1 kilobyte (K) of addressable memory in memory 104.

The software 108 stored in the memory 104 is operable on the processor 102 to cause the system 100 to perform various tasks or operations. Some such tasks include causing the system 100 to virtualize, emulate, or virtualize and emulate one or more resources, such as resource 1 112 or resource X 114. However, some embodiments do not virtualize or emulate resources. Further detail of the software is provided below.

The operating system 110 stored in the memory 104 controls operation of the system 100 and applications. The operating system 110 performs basic tasks, such as recognizing input from one or more input devices, sending output to a display, keeping track of files and directories within the memory 104, and controlling peripheral devices, such as resource 1 112 or resource X 114. The operating system 110 of system 100 includes various operating systems 110 such as real-time, multi-user, multiprocessing, multitasking, and multithreading operating systems. Some examples of such operating systems include the Microsoft Windows® family of operating systems, UNIX, Linux, the O/S 390 Enterpriser Server operating system available from International Business Machines, application specific operating systems, or virtually any other operating system.

The resources 112 and 114 of the system 100 include virtually any type of system resource. The number of resources varies based on the particular implementation. Some embodiments include no resources, while other embodiments include one or more resources. Some such resources include peripheral devices such as video cards, Small Computer System Interface (SCSI) cards, a wired or wireless network interface cards (NIC), a modem, or virtually any other peripheral device coupleable to or integrated within a main-board or motherboard of the system 100. Other such resources include data items within the system such as data stored in the memory 104, data in a register of the processor 102, or any other data available on or through the system 100. Yet other such resources include applications, operating system 110 elements or resources, machine-code commands, processor portions, or virtually any other resource of the system 100.

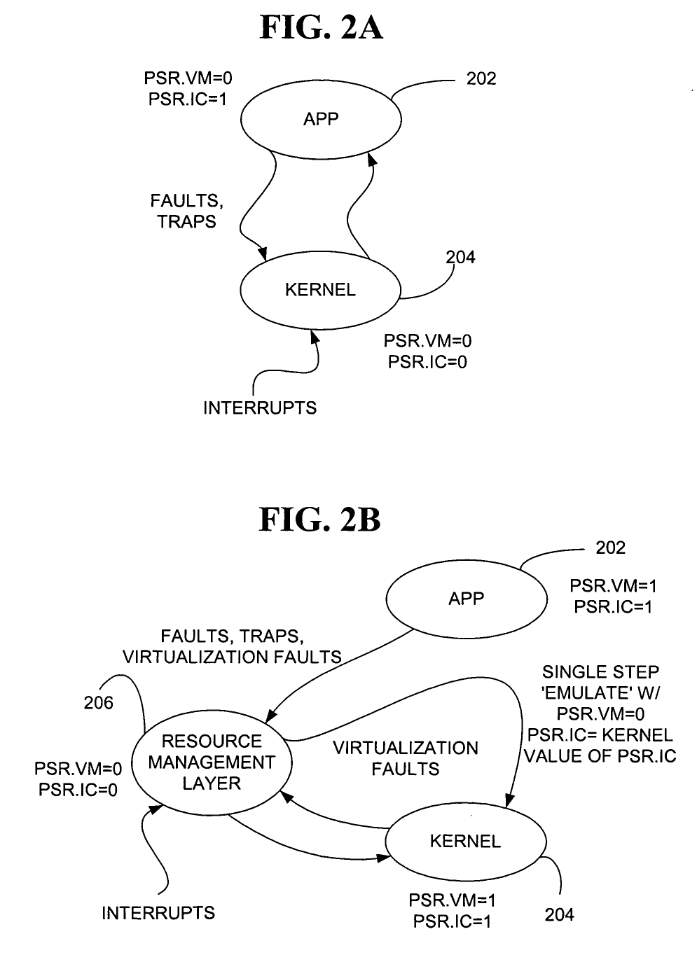

FIG. 2A is a diagram of a system according to an example embodiment. FIG. 2A illustrates a system before a resource management layer is started on a system. The system of FIG. 2A includes an application 202 and an operating system kernel 204. The system, as illustrated, includes privilege levels. The privilege level for the application 202 and the kernel 204 are determined by fields in the Processor Status Registers (PSR) called the Virtual Machine (VM) and the Interrupt Collection (IC). These are designated as psr.vm and psr.ic respectively. The psr.vm field is used to distinguish between the highest privilege level for the resource management layer and the normally-highest privilege level for the kernel. In some embodiments, a separate field in the PSR, called the Current Privilege Level, designated as psr.cpl, is used to distinguish between the privilege of the kernel versus the lower privilege of applications. These registers (i.e., psr.vm, psr.ic, and psr.cpl) are initially set to provide the kernel 204 the highest privilege level and the application 202 to a lesser privilege level where interrupts from an application are captured by the kernel 204.

FIG. 2B is a diagram of a system according to an example embodiment. FIG. 2B illustrates a system after a resource management layer 206 is started on a system. The resource management layer 206 operates to capture interrupts from both the application 202 and the kernel 204. When the resource management layer 206 is initialized, the resource management layer creates a copy of kernel 204 register values in memory. Some of these register values include the psr.vm, psr.ic, and psr.cpl register values. The privilege levels of the application 202 and the kernel 204 are then modified to provide the resource management layer with the highest privilege level. For example, the psr.vm and psr.ic values of the application 202 and the kernel 204 are both modified in FIG. 2B to equal one while the same values for the resource management layer 206 are set to zero, the highest privilege level of the embodiment. Other registers and privilege settings can be modified to cause the resource management layer 206 to capture interrupts from the application 202, the kernel 204, or virtually any other component, application, routine, or process on a system for a specific embodiment.

Modifying the privilege level of the application 202 and the kernel 204 cause resources associated with the modified privileged level to become privileged. When attempts to access one of these privileged resources are made, an interrupt occurs. When an interrupt occurs, an interrupt vector table (IVT) directs the interrupt to a routine stored in a memory for handling the interrupt. In some embodiments, the resource management layer 206, when started, modifies values in this interrupt vector table. In other embodiments, the resource management layer 206 creates a copy of the interrupt vector table in memory, modifies the copy to direct interrupt to resource management layer 206 routines for processing an interrupt, and then modifies a register value in a processor directing the processor to the interrupt vector table. An example of such a register value is control register 2 in the Intel® Itanium® architecture, commonly referred to as CR.IVA (control register—interrupt vector address). In some embodiments, the resource management layer 206 modifies the copy of the IVT to include the resource management layer 206 routines for processing an interrupt.

Once the privilege levels of the kernel 204 and the application(s) 202 have been modified and the interrupt vector table or the interrupt vector address is modified, the resource management layer 206 virtualizes access to the privileged resources. All access to the privileged resources flows through the resource management layer 206, to resource management layer 206 routines for processing access to a privileged resource. The flow of access through the resource management layer 206 is not perceived by the application 202 or kernel 204. Thus, the resource management layer 206 virtualizes the access to the privileged resources.

The resource management layer 206 routines can perform various functions or no functions at all. For example, a resource management layer 206 in one embodiment allows the access to the privileged resource allowing the kernel 204 to process the access request in accordance with native kernel 204 processes or calls and takes no further action.

In some embodiments, the resource management layer 206 captures a privileged resource access attempt and emulates access to the privileged resource. For example, if a processor or element thereof, routine, application, or other privileged resource is known to have bugs, access to that resource can be emulated in a resource management layer 206 routine. This emulation is performed, in some embodiments, by substantially preventing access to the privileged resource, and in an additional embodiment, returning an expected return value from the resource management layer 206 routine to a privileged resource access requestor.

Other embodiments include further routines including logging of access requests and associated data. Some embodiments include varying routines including a combination of functions, such as emulating and logging in a single routine. Further, each privileged resource may include a substantially unique routine for processing the privileged resource access request.

Some resource management layer 206 embodiments include capturing resource access requests and single stepping through execution of either application 202 instructions or kernel 204 instructions. In some embodiments, this includes manipulating a register value, such as Processor Status Registers—Single Step (psr.ss) in the Intel® Itanium® architecture that causes the kernel 204 to return execution control to the resource management layer 206 after each instruction is executed. By single stepping through a privileged resource access attempt, a resource management layer 206 routine can execute a single instruction in the kernel at the highest privilege level, and then regain control of execution after that single instruction executes. This single step functionality provides a wide variety of abilities to resource management layer users.

Another embodiment provides the resource management layer 206 the ability to single-step kernel 204 instructions even when an interrupt occurs and the kernel 204 psr.vm register value is one and the psr.ic register value is zero. When such an interrupt occurs, sometimes referred to as a nested interrupt, the kernel 204 normally encounters an error. The kernel 204 encounters an error because when the psr.ic value is zero, the system does not know where to return system control after the single-step interrupt.

In operation, this embodiment includes the resource management layer 206 creating a copy of kernel 204 register values in memory and then modifying the kernel 204 register values to provide the resource management layer 206 with the highest privilege level. Providing the resource management layer 206 with the highest privilege level includes setting both the psr.vm and psr.ic values to zero and the kernel 204 psr.vm and psr.ic values both to one. Subsequent kernel 204 privileged resource access attempts will cause an interrupt to the resource management layer 206 for handling access to the privileged resource, such as a privileged kernel 204 instruction.

When the resource management layer 206 receives an interrupt from the kernel 204 attempting to execute a privileged kernel 204 instruction, the resource management layer resets the initial kernel 204 register values from memory. The resource management layer 206 then sets the kernel's 204 psr.vm value to zero and the kernel's psr.ss value to 1. Further, the psr.ic value is set to whatever the kernel 204 believes the value to be. The psr.ic value can therefore be either zero or one.

If the psr.ic value is zero, the kernel 204 will not cause data, such as an instruction pointer, to be stored in a register to tell the system where to return execution to after performing a single step. To handle this in cases where the kernel psr.ic value is zero, the resource management layer 206 precomputes the data necessary to return execution to the kernel 204 after the resource management layer 206 single steps a kernel 204 instruction. This precomputed data includes identical data to the data stored in the register by the kernel 204 when the psr.ic value is one. The instruction pointer that tells the kernel where to return execution after performing the single step instruction is determined by placing an instruction pointer with the precomputed data that is equal to the current kernel 204 instruction plus one. In some architectures including instructions arranged in bundles of three, this includes a pointer to a next instruction in the bundle or the first instruction in the next bundle of instructions.

Once the kernel 204 register values are returned to their pre-resource management layer 206 values and, if necessary, data is stored in memory for handling a kernel 204 state when the psr.ic value is zero, the instruction from the kernel 204 causing the interrupt is sent to the kernel 204. The instruction then executes normally, as if the resource management layer 206 were not present, except that the instruction is single stepped. Once the kernel 204 instruction executes, a single step interrupt occurs, returning execution to the resource management layer 206.

If the kernel 204 psr.ic value is one, then the instruction pointer and other data placed in the register by the kernel 204 directs execution to the next kernel instruction. However, the resource management layer 206 first resets both the kernel psr.vm and psr.ic values to one. However, if the psr.ic value is zero, the resource management layer 206 goes to the precomputed instruction pointer and other data stored in memory to determine where to return execution in the kernel 204. Once the resource management layer 206 determines where to return execution, both the kernel psr.vm and psr.ic values are reset to one. Execution is then returned to the kernel 204.

To restore a system to its original state, the interrupt vector table, the interrupt vector address, or both are returned to their original values. Further, the original resource privilege levels are restored.

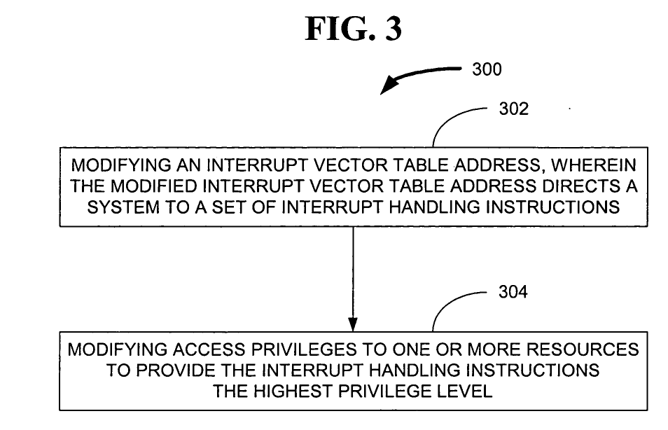

FIG. 3 is a flow diagram of a method 300 according to an example embodiment. The method 300 includes modifying an original interrupt vector table address 302, wherein the modified interrupt vector table address directs a system to a set of interrupt handling instructions, and modifying access privileges to one or more resources to provide the interrupt handling instructions the highest privilege level 304. For example, modifying access privileges to the one or more resources includes modifying the access privileges so that the kernel does not have the highest privilege level. The original interrupt vector table address includes an address of a routine a system uses to handle an interrupt prior to the execution of the method 300. The method 300 can be performed at any time. For example, once the system and operating system is running, the method then executes to cause certain resources to be privileged for subsequent access attempts.

In some embodiments, the interrupt handling instructions include instructions to cause an attempted resource access to occur as requested by a requestor such as an operating system kernel, an application, or other requestor. In some embodiments, the one or more resources of the method 300 include data items, hardware elements such as peripheral devices or a processor in a single or multi-processor system, portions of the hardware elements, or virtually any other resource available in a system performing the method. In some embodiments, the interrupt handling instructions include instructions to emulate access to the one or more resources.

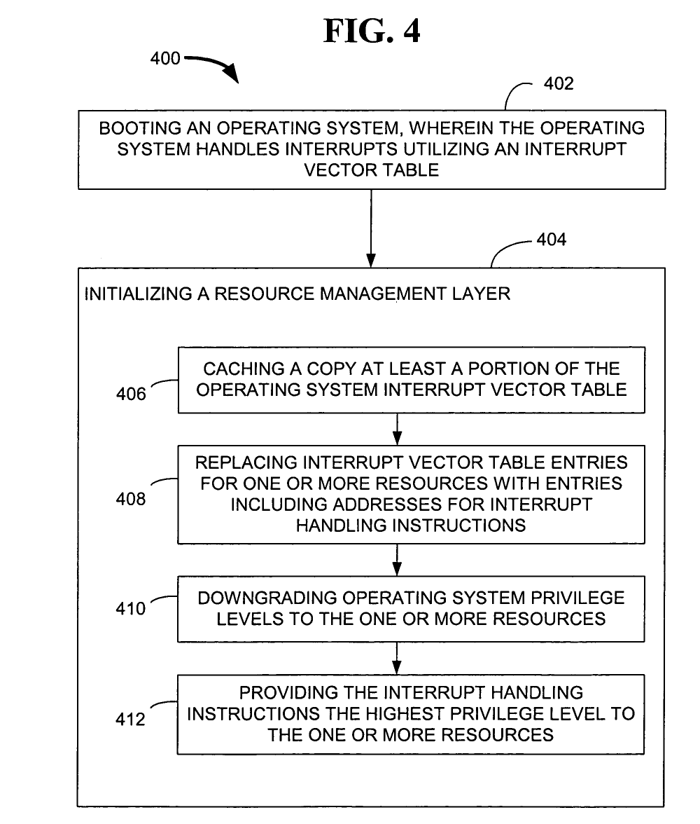

FIG. 4 is a flow diagram of a method 400 according to an example embodiment. The method 400 includes booting an operating system on a computing device, wherein the operating system handles interrupts utilizing an interrupt vector table 402. The method 400 further includes initializing a resource management layer 404. Initializing the resource management layer 404 includes caching a copy of at least a portion of the operating system interrupt vector table 406 and replacing interrupt vector table entries for one or more resources with entries including addresses for interrupt handling instructions 408 or with interrupt handling instructions 408 directly in the interrupt vector table. Initializing the resource management layer 404 further includes downgrading operating system privilege levels to the one or more resources 410 and providing the interrupt handling instructions the highest privilege level to the one or more resources 412. The resource management layer, once initialized, causes access to the privileged resources to be virtualized. Some interrupt handling instructions cause access to one or more privileged resources to be emulated.

It is emphasized that the Abstract is provided to comply with 37 C.F.R. §1.72(b) to allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments include more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

What is claimed is:

1. A method comprising:
replacing at least one entry in an original interrupt vector table to handle access to a privileged resource according to one or more resource management routines; and
modifying an operating system privilege level to one or more resources such that subsequent access to the privileged resource causes an interrupt, and processing of the interrupt is directed to the resource management routines to handle access to the privileged resource.

2. The method of claim 1, wherein the privileged resource comprises a hardware resource.

3. The method of claim 1, wherein the privileged resource comprises an instruction.

4. The method of claim 1, wherein the privileged resource comprises a data item.

5. The method of claim 1, wherein replacing at least one entry in the original interrupt vector table includes caching a copy of the original interrupt vector table and replacing each entry in the original interrupt vector table.

6. The method of claim 5, further comprising:
restoring the original interrupt vector table from the cached copy; and
restoring the modified operating system privilege levels to original levels.

7. The method of claim 1, wherein the one or more routines to handle access to the privileged resource operates laterally to an operating system and on top of system hardware and causes the privileged resource to be virtualized.

8. The method of claim 7, wherein causing the privileged resource to be virtualized includes emulating execution of the privileged resource.

9. The method of claim 8, wherein causing the privileged resource to be virtualized includes causing single-step access to the privileged resource by providing full privileges to the privileged resource in each step except emulated steps.

10. A method comprising:
modifying an interrupt vector table address, wherein the modified interrupt vector table address directs a system to a set of interrupt handling instructions; and
modifying access privileges to one or more resources to provide the interrupt handling instructions a highest privilege level.

11. The method of claim 10, wherein the interrupt handling instructions include instructions to cause an attempted resource access to occur.

12. The method of claim 10, wherein the interrupt handling instructions include instructions to emulate an attempted resource access.

13. The method of claim 10, wherein the one or more resources comprises a system resource.

14. A method comprising:
booting an operating system, wherein the operating system handles faults utilizing an interrupt vector table;
initializing a resource management layer, wherein initializing the resource management layer includes:
caching a copy of at least a portion of the interrupt vector table,
replacing interrupt vector table entries for one or more resources with entries including addresses for fault-handling instructions,
downgrading operating system privilege levels to the one or more resources; and
providing the fault-handling instructions a highest privilege level to the one or more resources.

15. The method of claim 14, wherein the fault-handling instructions include operating system calls.

16. The method of claim 14, wherein the resource management layer, once initialized, causes privileged resources to be virtualized.

17. The method of claim 14, wherein the fault-handling instructions cause emulated access to the one or more resources.

18. The method of claim 14, wherein the one or more resources are system resources.

19. A system comprising:
a processor;
a memory;
an interrupt vector table stored in the memory; and
software in the memory and operable on the processor to cause the system to:
boot an operating system, wherein the operating system handles faults utilizing the interrupt vector table, and
virtualize one or more resources, wherein virtualizing one or more resources includes:
caching a copy of at least a portion of the interrupt vector table,
replacing the interrupt vector table with a virtualizing interrupt vector table including addresses for fault-handling instructions,
downgrading operating system privilege levels to the one or more resources, and
providing the fault-handling instructions a highest privilege level to the one or more resources.

20. The method of claim 19, wherein the fault-handling instructions include operating system calls.

21. The method of claim 19, wherein the fault-handling instructions cause emulated access to the one or more resources.

22. The method of claim 19, wherein the one or more resources comprises a hardware resource.

23. The method of claim 19, wherein the one or more resources comprises an instruction.

24. The method of claim 19, wherein the one or more resources comprises a data item.

25. A machine readable medium, with instructions thereon, to cause a properly configured machine to:
cache a copy of an original interrupt vector table;
replace the original interrupt vector table with a virtual interrupt vector table, the virtual interrupt vector table including an instruction set to virtualize access to a privileged resource; and
modify an operating system privilege level to the privileged resource, wherein subsequent access to the privileged resource causes an interrupt, wherein processing of the interrupt is directed to the instruction set to handle access to the privileged resource by the virtual interrupt vector table.

26. The machine readable medium of claim 25, further comprising:
restoring the original interrupt vector table from the cached copy; and
restoring the modified operating system privilege level to an original level.

27. The machine readable medium of claim 25, wherein the instruction set to handle access to a privileged resource causes the privileged resource to be virtualized, further wherein the instruction set causes access to the privileged resource to be emulated.

28. A method comprising:
capturing a privileged resource access attempt from a process before the attempt reaches an operating system; and
virtualizing access to a privileged resource.

29. The method of claim 28, wherein virtualizing access to the privileged resource comprises emulating access to the privileged resource by providing the process with an expected return, and bypassing actual access to the privileged resource.

30. The method of claim 28, wherein virtualizing access to the privileged resource comprises forwarding the access attempt to the operating system, wherein the operating system processes the access attempt.

31. The method of claim 31, wherein the process comprises an application executing on top of an operating system.
